(19) United States
(12) Patent Application Publication
(10) Pub. No.: US 2009/0210269 A1
(43) Pub. Date: Aug. 20, 2009

(54) Method for Operating a Renewable Energy Power Generation Facility

(76) Inventor: Rovshan Sade, Raleigh, NC (US)

Correspondence Address: COATS & BENNETT, PLLC, 1400 Crescent Green, Suite 300, Cary, NC, 27518, US

(21) Appl. No.: 12/033,477

(22) Filed: Feb. 19, 2008

(51) Int. Cl. G06Q 10/00

(52) U.S. Cl. 705/7

(57) ABSTRACT

A method is described for operating a renewable power generation facility having a plurality of individual power generation units for generating power from a renewable energy source. In one exemplary embodiment, the method comprises selling the power generation units in the power generation facility to individual investors 16, supplying power generated by individual power generation units in the power generation facility to a public power grid, and monitoring the amount of power supplied by individual ones of said power generation units to said power grid to enable the individual investors 16 to receive credits for the power contributed to the public grid by their respective power generation units. The credits may be in the form of an offset to the investors 16 electricity bill.

### BACKGROUND

The present invention relates generally to the generation of electricity from alternative energy sources and, more particularly, to a business model for operating renewable power generation facilities.

On-going conflict in the Middle East, concerns for global warming, and rising oil prices are fueling the push for renewable energy sources such as wind and solar power. Today, approximately 70% of the electricity generated in the United States is produced by burning fossil fuels, such as coal, natural gas, and petroleum. Another 19% is produced from nuclear power and approximately 1% is produced from hydroelectric power. Energy produced from alternative energy sources, such as wind and solar power, account for less than 1% of the total electricity produced in the United States. Our reliance on fossil fuels and nuclear power has several drawbacks. While fossil fuels are comparatively inexpensive, there is only a limited supply of fossil fuels, which will eventually be depleted if alternative energy sources are not found. Further, the burning of fossil fuels to produce electricity emits greenhouse gases that contribute to global warming. The main problem with nuclear power is how to dispose of hazardous waste.

Solar energy and wind power are promising alternative energy sources that can reduce reliance on fossil fuels for generating electricity. Solar energy and wind power are renewable resources so there is no concern about future depletion of these resources. Further, the generation of electricity from solar energy and wind power does not emit greenhouse gases and is therefore considered more environmentally friendly. Also, generation of electricity from renewable energy sources does not generate hazardous by-products that need to be disposed.

While solar energy and wind power are more affordable today than ever before, these renewable energy resources have their drawbacks. Because solar energy and wind power are very diffuse energy sources, renewable power generation facilities are typically characterized by a large number of individual generation units that are spread over a large land area. Consequently, solar and wind power facilities tend to be more costly to build and operate, and the electricity produced from these facilities is more costly to consumers.

Accordingly, there is a need for improved methods for operating of renewable power facilities that reduce the cost of electricity produced by such facilities.

### SUMMARY

The present invention relates to a method for operating a large-scale renewable power generation facilities, such as solar generation facilities and wind generation facilities. Renewable power generation facilities are typically characterized by a large number of individual generation units that are spread over a large land area. Individual investors can purchase and hold title to individual power generation units at the power generation facility. The power generation units are connected to a public power grid to provide energy produced by the renewable power generation facility to the public grid. Power contributed by each individual power generation unit is separately measured to enable the individual investors to receive credits for the power contributed to the public grid by their respective power generation units. Operation and maintenance of the power generation units may be commonly managed by the operating company.

The individual owners may receive a credit for the power produced from their respective power generation units, as well as any benefits, such as tax benefits, that flow from ownership of the power generation unit. Credits earned by the individual owners may be applied to reduce the owners' electricity bills and appear on billing statements from the public utility companies. Credits can also take the form of direct payments or dividends to the individual investors. The business method for operating a renewable power generation facility benefits consumers by providing their energy needs at a lower cost. Consumers benefit from the economies of scale of a large-scale power generation facility while retaining the advantages from asset ownership, such as tax credits and incentives. Consumers can purchase as many individual power generation units as they want to provide all of part of their energy needs. Further, the consumer is not burdened with engineering and maintenance of the energy generating assets.

The public utility companies also benefit by gaining access to renewable energy that diversifies their power portfolios and provides renewable energy credits (RECs) to meet Renewable Portfolio Standard (RPS) requirements without incurring a power purchase premium. In embodiments where the renewable power generation facility is fully funded by private investors, the utility company can gain access to RECs without up-front investment in the RPG facility. In the case of solar power facilities, the generating assets are highly efficient during peak hours.

### BRIEF DESCRIPTION OF THE DRAWINGS

FIG. 1 illustrates an exemplary business model for operating a renewable energy power generation facility.

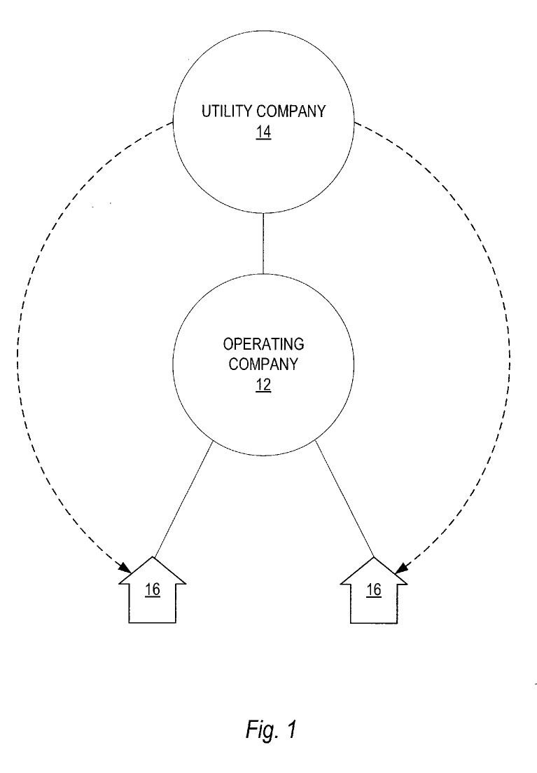

FIG. 2 illustrates an exemplary power generation system based on the business model.

FIG. 3 illustrates an exemplary method for operating a renewable power generation facility based on the business model.

### DETAILED DESCRIPTION

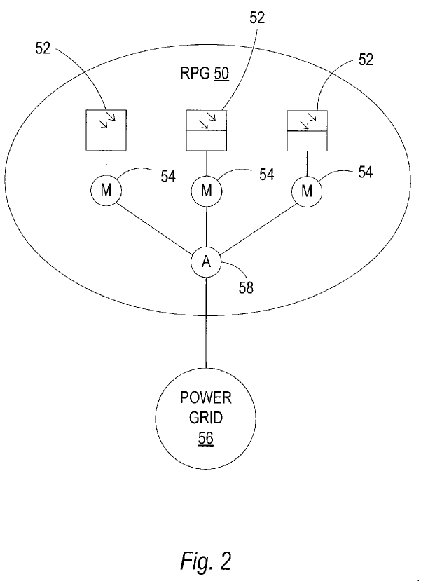

Referring now to the drawings, a business model 10 for operating renewable power facilities 50 is shown. The main components of the business model comprise an operating company 12 that operates a renewable power generation (RPG) facility, a utility company 14 that controls a public power grid 56 that provides electrical power to consumers, and individual investors 16 that own homes or businesses connected to the public power grid 56. The RPG facility 50, shown in FIG. 2, comprises a large-scale power generation facility 50 having a plurality of individual power generation units (PGUs) 52. Typically, the PGUs 52 are located at the same site. Only three PGUs 52 are shown in FIG. 2; however, those skilled in the art will readily appreciate that a typical RPG facility could include hundreds of PGUs 52. The RPG facility 50 may comprise a solar RPG facility 50 or wind RPG facility 50. The PGUs 52 (solar or wind) may be purchased individually by individual investors 16, e.g., home owners or business investors 16. The RPG facility 50 connects to the public power grid 56. The RPG operator enters into an agreement with the utility company 14 to provide power generated by the individual RPGs to the grid 56 at market prices. The amount of power contributed by each PGU 52 is measured and the individual investors 16 receive a credit at the end of each month based on the amount of power contributed to the power grid 56. If the individual investors 16 are home owners or business operators that are connected to the power grid 56, the home owner or business operator may receive the credit in the form of a discount or offset on the individual investor's 16 electricity bill. The credit may be shown on the individual investor's billing statement so that the individual investor 16 can see the benefits of owning the PGU 52.

In one exemplary embodiment, the operating company 12 may be paid by the utility company 14 to operate the RPG facility 50. Those skilled in the art will appreciate that the operating company 12 could subcontract the operation of the RPG facility 50 to another company. Alternatively, the utility company 14 may operate the RPG facility 50. To compute credits due to the investors 16, the utility company 14 deducts the operating costs OC (e.g., the amount paid the operating company 12) from the gross value GV (market price) of the energy contributed by the RPG facility 50 to the power grid to get the net value (NV) of the energy to the utility company 14. The utility company 14 may also deduct additional administration expenses and connection fees from the net value to determine the total value of the credits due to the individual investors 16. The total credits is given by:

T_{C}=GV−OC−Fees

The total credits can then be allocated to the individual investors 16 in proportion to the amount of power contributed by each investor's PGU 52.

In one exemplary embodiment, the RPG facility 50 may be organized in a manner similar to a condominium development in which a corporation holds the property in trust on behalf of the investors/owners 16 as a group and each investor/owner 16 holds title to an individual PGU 52. Alternatively, the land where the RPG facility 50 is located may be subdivided and sold along with individual PGU 52s to individual investors/owners 16. A portion of this land can be set aside and commonly owned to provide facilities for operating and maintaining the RPG facility 50.

FIG. 2 illustrates an exemplary RPG facility 50 according to one embodiment of the invention. The RPG facility 50 comprises a plurality of individual power generation units (PGUs 52), which may comprise solar generators, wind generators, or other form of renewable energy generator. Multiple solar and wind generators can be connected together by an inverter to create a Single PGU 52. The individual PGU 52s are connected to a power grid 56 through an aggregator 58 that aggregates power from all of the PGUs 52. Individual power meters 54 for each PGU 52 monitor and measure the amount of power contributed by corresponding PGUs 52 to the power grid 56. The power meters 54 connect to a central computer 62 for keeping records concerning the power produced and contributed by each PGU 52. This is useful not only for accounting purposes, but also to monitor performance of the PGUs 52 and to detect when a PGU 52 needs servicing.

The central computer 62 may be a computer under the control of the operating company 12. In this case, the central computer 62 keeps detailed records concerning the power contributed to the power grid 56. For example, the central computer 62 may store reports of daily power generation in a database for subsequent processing. In one exemplary embodiment, the central computer 62 may provide a power report periodically to an accounting server 64, which may be controlled by the utility company 14. The accounting server 64 can calculate the credit due to each individual investor 16 based on the power contributed by their respective PGUs 52 and on the operating costs as previously described. The accounting server 64 may generate monthly electric bills for investors 16 reflecting credits for power contributed to the power grid 56. In other embodiments, a central computer 62 maintained by the operating company 12 may also function as the accounting server 64 to calculate credits due to individual investors 16. The accounting server could also be operated by an independent energy broker.

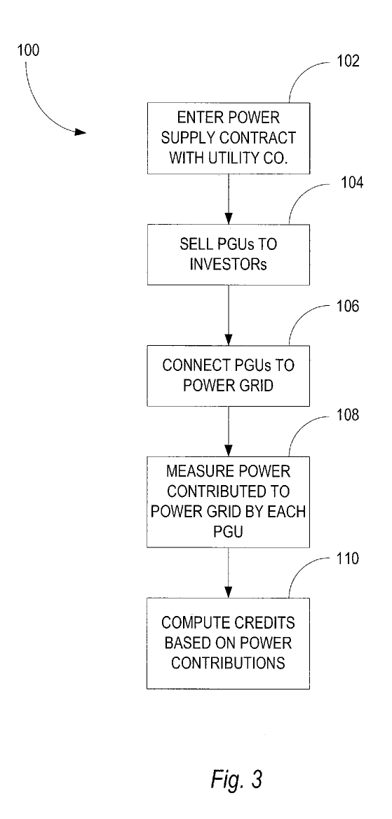

FIG. 3 illustrates an exemplary method of operating a renewable power generation facility according to one embodiment of the invention. The operating company 12 enters into a contract with a utility company 14 to supply power generated by PGUs 52 at the RPG facility 50 (block 102) and sells individual power generation units in the power generation facility to individual investors 16 (block 104). Alternatively, the utility company may construct the RPG facility 50 and sell the PGUs 52 to recoup its investment. The PGUs 52 may be previously constructed units or may be added after the investor 16 makes a purchase. The operating company 12 connects the individual PGUs 52 to a power grid 56 maintained by the utility company 14 and supplies power generated by individual PGUs 52 in said RPG facility 50 to the public power grid 56 (block 106). The operating company 12 measures the power contributed by each PGU 52 to the power grid 56 to enable the individual investors 16 to receive credits for the power contributed to the power grid 56 by their respective PGUs 52 (block 108). As previously described, a separate power meter 54 may be installed to measure the power contributed by each PGU 52. The operating company 12, utility company 14, or third party may subsequently calculate a credit due to each investor 16 based on the amount of power contributed to the power grid 56 by each investor's PGU 52 (block 110). The credit may be given to the investor 16, for example, as an offset or discount on the investor 16 electrical bill or in the form of a direct payment or dividend. Other forms of credit may also be given.

At the beginning of each accounting period (e.g., one calendar year or one fiscal year), representatives from the operating company 12 and utility company 14 may meet to agree on a budget of operating costs for the upcoming year. Preferably, a conservative estimate of the operating costs should be used for budgeting to ensure that the actual operating costs are fully covered. It is expected that the operating costs for the RPG facility 50 will not vary much from one month to another. Therefore, the budgeted operating costs may be paid in twelve equal monthly installments by the utility company 14 to the operating company 12. It will be appreciated, however, that operating costs may, in some situations, vary from month to month. In this case, the representatives from the operating company 12 and utility company 14 may agree to a budget where the monthly payments for operating costs vary from one month to another throughout the year to reflect varying operating costs. Also, those skilled in the art will appreciate that operating costs could be paid on a different time schedule, such as quarterly.

The payments received by the operating company 12 from the utility company 14 are used to pay all maintenance and operating expenses of the RPG facility 50, as well as design and engineering fees. Therefore, the individual investor 16 does not have the burden of maintaining the PGUs 52. Additionally, the operating company 12 may use a portion of the operating costs to insure the RPG facility 50 and the individual PGU 52s against casualty losses due to events such as hurricanes, tornadoes, floods, vandalism, etc. Warranty expenses may also be paid out of the operating costs. Thus, the risk to the investor 16 is minimized.

Any surplus of operating costs paid by the utility company 14 to the operating company 12 may be held in trust by the operating company 12 and paid to the individual investors 16 as a dividend or bonus at the end of each year. The operating company 12 may hold back a portion of the surplus each year to maintain a contingency fund for large, unexpected, and uninsured expenses or losses.

In addition to credits from the public utility and dividends from the operating company 12, the individual investors 16 receive all of the benefits of ownership in the PGU 52s. The individual investors 16 hold full legal title to their respective PGU 52s and therefore can claim all of the benefits due to the ownership of the assets, such as tax credits, renewable energy credits, etc. Federal and many state governments provide a tax credit based on the cost of a new solar installation. For example, the federal Residential Solar and Fuel Cell Tax provides a tax credit worth 30% of the cost of a new solar installation up to $2000. The North Carolina Renewable Energy Tax Credit provides a state tax credit equal to 35% of the cost of a new solar power installation up to $10,500.

In some embodiments of the invention, the individual investors 16 and owners of the PGUs 52 may have the option of applying to receive benefits of an incentive program rather than receive a credit directly from the utility company 14. For example, under the North Carolina Green Power Production Incentive, investors 16 who are customers of the utility company 14 may be eligible to receive up to $0.22 per kilowatt hour supplied to the power grid 56. Similarly, under the TVA Green Power Partners Program, investors 16 may be eligible to receive up to $0.20 per kilowatt hour supplied to the public grid 56. In this case, the power supplied to the public grid 56 is monitored and reported to the program manager for the applicable incentive program. The individual investors 16 then receive their credit for contributing to the power grid 56 from the incentive program rather than the utility company 14. In cases where the investor/owner 16 elects to participate in an incentive program that is not managed by the utility company 14, the investor/owner 16 may be responsible for payment of a proportionate share of the operating costs of the RPG facility 50 out of his/her individual proceeds from the incentive program.

For individual investors 16 seeking to offset their carbon footprint and set an example in their community, the renewable energy power generation model offers clean, reliable solar and wind energy that is less expensive than traditional solar and wind installations. Unlike traditional roof-managed solar arrays on individual homes and businesses, ownership of a solar or wind PGU 52 in a large-scale RPG facility 50 eliminates the need for costly custom design and engineering, which greatly reduces cost and speeds installation. Customers can purchase one or more power generation units in a large-scale solar facility that is maintained by professional staff while receiving all of the benefits attributable to ownership of the PGU 52.

Owners of existing homes and properties can purchase PGUs 52 directly from the operating company 12. Because the systems are already engineered, the purchased PGUs 52 can be installed and operating within 30 days. Home builders can purchase PGUs 52 for resale along with a new home to create additional incentive to prospective home owners to purchase homes from the builder. In this case, the cost of the PGU 52 can be included in the cost of the home and financed along with the home. Because the energy costs for the new home will be offset by the credits received for power contributed to the public grid 56, the homeowner can expect to have low electricity bills.

In some embodiments, the PGUs 52 can be purchased by a single investor and resold. For example, a large investor such as a bank or other financial institution could purchase all or a substantial part of the PGUs 52 at the RPG facility 50 and resale the PGUs to individual investors. The original investor in this case could offer various ways to finance the purchase, such as lease options, to the individual investors.

The public utility companies also benefit by gaining access to renewable energy that diversifies their power portfolios and provides renewable energy credits to meet RPS requirements without a power purchase premium or, in some cases, any up-front investment. In the case of solar power facilities, the generating assets are highly efficient during peak hours.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of operating a renewable power generation facility having a plurality of individual power generation units for generating power from a renewable energy source, said method comprising:
selling said power generation units in said power generation facility to individual investors;
supplying power generated by individual power generation units in said power generation facility to a public power grid;
monitoring the amount of power supplied by individual ones of said power generation units to said power grid to enable the individual investors to receive credits for the power contributed to the public grid by their respective power generation units.

2. The method of claim 1 further comprising commonly managing operation of said power generation units at said power generation facility.

3. The method of claim 1 further comprising calculating credits due said individual investors for the power supplied by their respective power generation units.

4. The method of claim 3 further comprising receiving payments from a utility company that controls said public grid for operating costs of said power generation facility.

5. The method of claim 4 wherein calculating credits due said individual investors based on the amount of power supplied to said power grid and the operating costs paid by said utility company.

6. The method of claim 3 wherein said investors are customers of the utility company and wherein credits are given by the utility company as an offset on the individual electricity bills of said individual investors.
